(19) United States
(12) Patent Application Publication
(10) Pub. No.: US 2009/0316804 A1
(43) Pub. Date: Dec. 24, 2009

(54) METHOD AND APPARATUS TO IMPLEMENT OFDMA RANGING IN WIMAX SYSTEM

(75) Inventors: Yuanjie Chen, Saratoga, CA (US); Lin Yang, Fremont, CA (US)

Correspondence Address: Frank F. Tian Esq.;Patent Agent, Apt. 4A, 331 Third Avenue, Long Branch, NJ, 07740, US

(73) Assignee: LEGEND SILICON CORP., FREMONT, CA (US)

(21) Appl. No.: 12/143,281

(22) Filed: Jun. 20, 2008

(51) Int. Cl. H04L 27/144

(52) U.S. Cl. 375/260; 375/340

(57) ABSTRACT

A communications processing device includes a rotor for rotating information associated with ranging subchannels in some symbols; and a single inverse fast Fourier transformer (IFFT), coupled to rotor, for subjecting the rotated information to a single IFFT along with information from all other channels. A method comprising the steps of: rotating information associated with ranging subchannels in some symbols; and subjecting the rotated information to a single IFFT along with information from all other channels.

### FIELD OF THE INVENTION

The present invention relates generally to a communications system, more specifically the present invention relates to a method and apparatus to implement orthogonal frequency division multiple access (OFDMA) ranging scheme in the WiMax system.

### BACKGROUND

WiMax system is an OFDMA transmission system. For each orthogonal frequency division multiplexing (OFDM) symbol, data are encoded on subcarriers in frequency domain. In turn, an inverse fast Fourier transform (IFFT) is performed and a cyclic prefix is added.

In the WiMax system, ranging is a special uplink procedure which is used to estimate channel delay for a time synchronization purpose. Ranging has four types, they are: initial ranging, periodic ranging, handover ranging, and bandwidth request. Initial ranging and handover ranging is done when a subject mobile station (MS) has not acquired initial synchronization. As a result, initial ranging and handover ranging need to use at least two periodic symbols.

In some symbols, a process associated with a suffix is required. Because of the process, two IFFTs are required as shown in FIG. 3. Therefore, it is desirable to use only prefix process and a single IFFT for processing both ranging information in some subchannels, as well as information in all other subchannels.

### SUMMARY OF THE INVENTION

A communications processing device in which only prefix process and a single IFFT is provided.

A communications processing device in which both ranging information in some subchannels, as well as information in all other subchannels are subjected to a single IFFT.

A communications processing device in which both ranging information in some subchannels, as well as information in all other subchannels are subjected to the same prefix process.

A communications processing device includes a rotor for rotating information associated with ranging subchannels in some symbols; and a single inverse fast Fourier transformer (IFFT), coupled to rotor, for subjecting the rotated information to a single IFFT along with information from all other channels.

A method comprising the steps of: rotating information associated with ranging subchannels in some symbols; and subjecting the rotated information to a single IFFT along with information from all other channels.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a first example of a time-domain illustration of initial ranging and handover ranging over two symbols.

FIG. 2 is a second example of a time-domain illustration of initial ranging and handover ranging over four symbols.

FIG. 3 is prior art OFDMA system.

FIG. 4 is an example of an initial or handover ranging diagram in accordance with one aspect of the present invention.

FIG. 5 is an example of flowchart in accordance with one aspect of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to using a combination of a single IFFT and a rotor for processing both ranging information in some subchannels, as well as information in all other subchannels. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of using a combination of a single IFFT and a rotor for processing both ranging information in some subchannels, as well as information in all other subchannels. The non-processor circuits may include, but are not limited to, a radio receiver, a radio transmitter, signal drivers, clock circuits, power source circuits, and user input devices. As such, these functions may be interpreted as steps of a method to perform processing both ranging information in some subchannels, as well as information in all other subchannels using a combination of a single IFFT and a rotor. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Ranging is a process for acquiring correct timing offset and power level adjustment between an incoming mobile station (not shown) and a base station (also not shown). In ranging, the mobile station transmits a code division multiple access (CDMA) code over one or more OFDM symbols. Ranging comprises initial ranging, which is performed during network initialization and registration (or re-registration). In turn, the mobile station is allowed to join the network and acquire correct parameters such as timing offset and power level adjustment.

Similarly, handover ranging is performed to acquire timing offset and power level adjustment with another base station before a mobile station can switch to it.

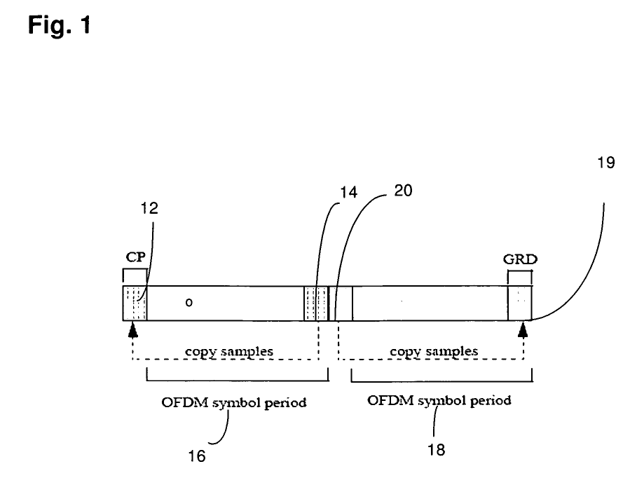

Referring to FIG. 1, when reduced to symbol level, a time-domain illustration of initial ranging and handover ranging over two symbols is shown. As can be seen, a cyclic prefix 12 is derived from first copy samples 14 after a first subject OFDM symbol period 16. For the second subject OFDM symbol period 18, a cyclic suffix 19 is derived from second copy samples 20 in front of a second subject OFDM symbol period 18.

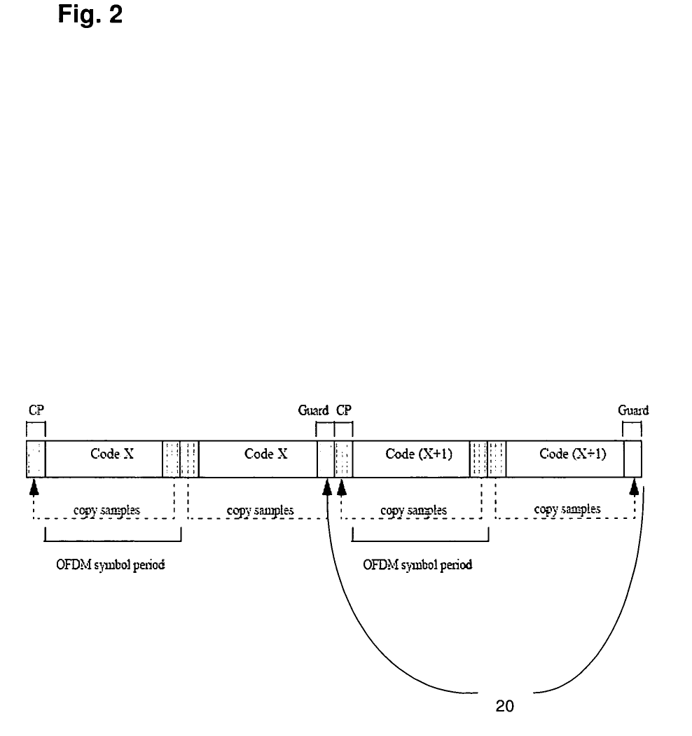

Referring to FIG. 2, similar to FIG. 1, a time-domain illustration of initial ranging and handover ranging over four symbols is shown. Note that cyclic suffix 20 is used on the 2^{nd} and 4^{th} symbols, while cyclic prefix is used on the 1^{st} and 3^{rd} symbols as on all symbols in the case of regular data transmission.

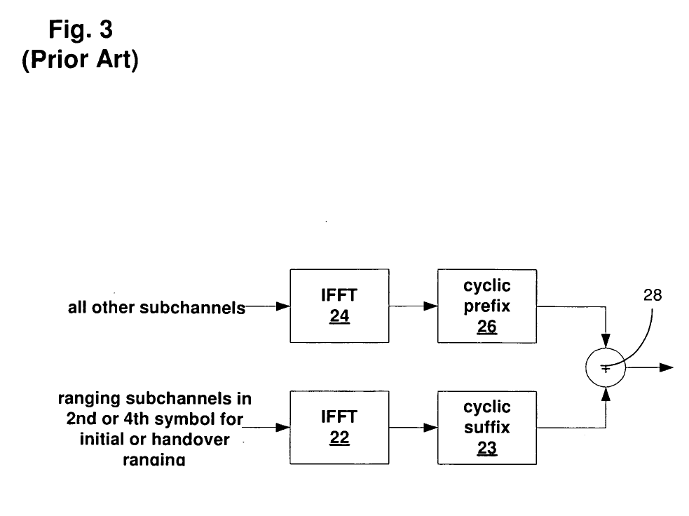

In OFDMA systems, ranging, including initial and handover ranging, only occupies a subset of subchannels. When ranging signal (initial or handover) is transmitted along with regular data signal on other subchannels, an apparent implementation is shown in FIG. 3.

Referring to FIG. 3, there are two paths, i.e. path I and path II, with two inverse Fourier transformers (IFFTs) respectively: a first IFFT 22 is used in path I for the 2^{nd} and 4^{th} symbols in either initial, or handover ranging, with cyclic suffix 23 added after IFFT 22. A second IFFT 24 is used in path II for all other processing, with cyclic prefix 26 added after IFFT 24. The results of path I and path II are added by adder 28 and used thereafter.

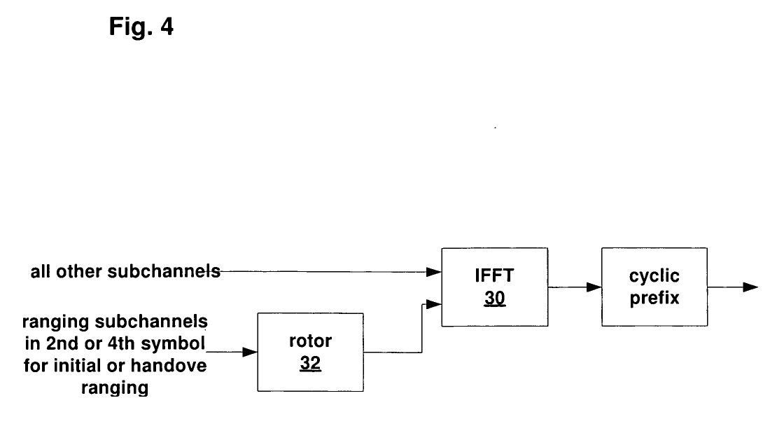

The present invention contemplates using a single IFFT block by integrating the two IFFT blocks into a single IFFT block as shown in FIG. 4.

Referring to FIG. 4, the initial ranging or handover ranging are implemented using a single IFFT 30 coupled to a rotor 32. It is known that in the time domain a cyclic suffix is equivalent to a cyclic time shift plus a cyclic prefix. In other words, for the cyclic suffixes associated with the 2^{nd} and 4^{th} symbols of the second and fourth ranging subchannels, rotor 32 is applied such that single IFFT 30 can be used after rotation 32 along with all other subchannels. In turn, cyclic prefix 34 is added thereafter.

As can be seen, the cyclic time shift in time domain is equivalent to rotations (multiplications by complex exponentials) of proportional angles for all subcarriers in frequency domain. This is shown in the equation below.

X_{cs}[k]=X_{cp}[k]e^{j2πN}^{_{cp}}^{k/N}

where N is FFT size, N_{cp} is the length of cyclic prefix.

In frequency domain, the ranging occupies disjoint subchannels from data transmission. The combining of ranging and data transmission is to simply fill an IFFT input buffer (not shown). Therefore, the advantage of the present is that only one IFFT is needed.

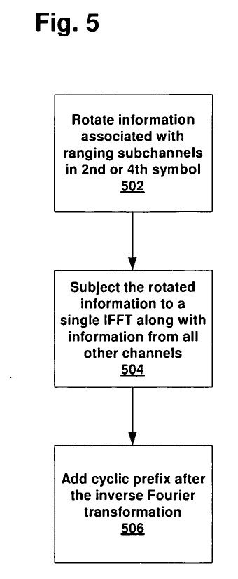

Referring to FIG. 5, a flowchart 500 for processing both ranging information in some subchannels, as well as information in all other subchannels using a combination of a single IFFT and a rotor. Rotate information associated with ranging subchannels in 2nd or 4th symbol for initial or handove ranging, in the frequency domain, (multiplications by complex exponentials) of proportional angles for all subcarriers in frequency domain (Step 502). Subject the rotated information to a single IFFT along with information from all other channels (Step 504). Add cyclic prefix after the inverse Fourier transformation (Step 506).

In practice of known WiMax systems, N_{cp}/N can only take the values of 1/32, 1/16, ⅛, ¼. So the complex rotation requires to store at most 32 complex coefficients. Moreover, there are symmetries among 32 complex coefficients. By making use of the symmetries, only 4 complex coefficients need to be stored.

The WiMax standard of the present invention refers to IEEE 802.16 or 4G wireless communications systems and their respective, concomitant subsystems.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. A communications processing device comprising:
a rotor for rotating information associated with ranging subchannels in some symbols; and
a single inverse fast Fourier transformer (IFFT), coupled to rotor, for subjecting the rotated information to a single IFFT along with information from all other channels.

2. The device of claim 1 further comprising coupled to an output of the single inverse fast Fourier transformer for adding cyclic prefix after the inverse Fourier transformation

3. The device of claim 1, wherein the some symbols comprises 2nd or 4th symbols of a sequence of OFDMA symbols.

4. The device of claim 1, wherein the information subject to rotation comprises initial or handover ranging information.

5. The device of claim 1, wherein the communications processing device conforms to WiMax standard.

6. A method comprising the steps of:
rotating information associated with ranging subchannels in some symbols; and
subjecting the rotated information to a single IFFT along with information from all other channels.

7. The method of claim 6 further comprising the step of adding cyclic prefix after the inverse Fourier transformation

8. The method of claim 6, wherein the some symbols comprises 2nd or 4th symbols of a sequence of OFDMA symbols.

9. The method of claim 6, wherein the information subject to rotation comprises initial or handover ranging information.

10. The method of claim 6 conforms to WiMax standard.
